(19) United States
(12) Patent Application Publication
(10) Pub. No.: US 2025/0358785 A1
(43) Pub. Date: Nov. 20, 2025

(54) WIRELESS COMMUNICATIONS METHOD, TERMINAL DEVICE, AND COMMUNICATIONS DEVICE

(71) Applicant: QUECTEL WIRELESS SOLUTIONS CO., LTD., Shanghai (CN)

(72) Inventors: Zheng ZHAO, Shanghai (CN); Ling LYU, Shanghai (CN)

(21) Appl. No.: 19/288,020

(22) Filed: Aug. 1, 2025

Related U.S. Application Data
(63) Continuation of application No. PCT/CN2023/141267, filed on Dec. 22, 2023.

(51) Int. Cl. H04W 64/00; H04W 56/00; H04W 84/06

(52) U.S. Cl. CPC H04W 64/006; H04W 56/0035; H04W 84/06

(57) ABSTRACT

A wireless communications method, a terminal device, and a communications device are provided. One example method includes: transmitting capability information; and receiving a first signal and a second signal that are sent by a first device, wherein the first signal and the second signal are used to determine first phase information that comprises a phase difference between the first signal and the second signal, a location at which the first device transmits the first signal is a first location, a location at which the first device transmits the second signal is a second location, and the first location is different from the second location, wherein the capability information indicates whether the first terminal device supports calculation of the phase difference between the first signal and the second signal.

### CROSS-REFERENCE TO RELATED APPLICATIONS

This application is a continuation of International Application No. PCT/CN2023/141267, filed on Dec. 22, 2023, the disclosure of which is hereby incorporated by reference in its entirety.

### TECHNICAL FIELD

This application relates to the technical field of communications, and more specifically, to a wireless communications method, a terminal device, and a communications device.

### BACKGROUND

During positioning, measuring phase information of a received signal enables a more accurate determination of the distance between a signal transmitter and receiver. Phase information can be obtained through phase estimation. However, the phase of the signal may be affected by factors such as noise, hardware processing at the transmitter and the receiver, which leads to uncertainty in phase estimation. In related technologies, it is difficult to eliminate the impact of the transmitter on phase measurement, specifically factors such as clock offset, hardware delay, and initial phase, making it impossible to obtain accurate phase measurement results.

### SUMMARY

The present application provides a wireless communications method, a terminal device, and a communications device. The following introduces various aspects of the present application.

According to a first aspect, a wireless communications method is provided. The method includes: sending, by a first terminal device, capability information; and receiving, by the first terminal device, a first signal and a second signal that are sent by a first device. The first signal and the second signal are for determining first phase information, and the first phase information includes a phase difference between the first signal and the second signal. A location at which the first device sends the first signal is a first location, a location at which the first device sends the second signal is a second location, and the first location is different from the second location.

According to a second aspect, a wireless communications method is provided. The method includes: receiving, by a first device, capability information sent by a first terminal device; and transmitting, by the first device, a first signal and a second signal to the first terminal device. The first signal and the second signal are used to determine first phase information which comprises a phase difference between the first signal and the second signal, a location at which the first device transmits the first signal is a first location, a location at which the first device transmits the second signal is a second location, and the first location is different from the second location.

According to a third aspect, a wireless communications method is provided. The method includes: receiving, by a second device, first phase information sent by a first terminal device. The first phase information is determined based on a first signal and a second signal, the first phase information comprises a phase difference between the first signal and the second signal, both the first signal and the second signal are sent by a first device, a location at which the first device sends the first signal is a first location, a location at which the first device transmits the first signal is a first location, a location at which the first device transmits the second signal is a second location, and the first location is different from the second location.

According to a fourth aspect, a terminal device is provided, where the terminal device is a first terminal device, and the terminal device includes: a first transmitting unit, configured to transmit capability information; and a first receiving unit, configured to receive a first signal and a second signal that are sent by a first device. The first signal and the second signal are used to determine first phase information which comprises a phase difference between the first signal and the second signal, a location at which the first device transmits the first signal is a first location, a location at which the first device transmits the second signal is a second location, and the first location is different from the second location.

According to a fifth aspect, a communications device is provided, where the communications device is a first device, and the communications device includes: a second receiving unit, configured to receive capability information sent by a first terminal device; and a second transmitting unit, configured to send a first signal and a second signal to the first terminal device. The first signal and the second signal are used to determine first phase information which comprises a phase difference between the first signal and the second signal, a location at which the first device transmits the first signal is a first location, a location at which the first device transmits the second signal is a second location, and the first location is different from the second location.

According to a sixth aspect, a communications device is provided, where the communications device is a second device, and the communications device includes: a third receiving unit, configured to receive first phase information sent by a first terminal device. The first phase information is determined based on a first signal and a second signal, the first phase information comprises a phase difference between the first signal and the second signal, both the first signal and the second signal are sent by a first device, a location at which the first device sends the first signal is a first location, a location at which the first device transmits the first signal is a first location, a location at which the first device transmits the second signal is a second location, and the first location is different from the second location.

According to a seventh aspect, a terminal device is provided, including a processor and a memory, where the memory is configured to store one or more computer programs, and the processor is configured to invoke the computer program in the memory so that the terminal device performs some or all of the steps in the method in the first aspect.

According to an eighth aspect, a communications device is provided, including a processor and a memory, where the memory is configured to store one or more computer programs, and the processor is configured to invoke the computer program in the memory so that the communications device performs some or all of the steps in the method in the second aspect and/or the third aspect.

According to a ninth aspect, an embodiment of this application provides a communications system, and the system includes the foregoing terminal device and/or the foregoing communications device. In another embodiment, the system may further include another device that interacts with the terminal device or the communications device in the solution provided in this embodiment of this application.

According to a tenth aspect, an embodiment of this application provides a computer readable storage medium, where the computer readable storage medium stores a computer program, and the computer program causes a terminal device and/or a communications device to perform some or all of the steps in the methods in the foregoing aspects.

According to an eleventh aspect, an embodiment of this application provides a computer program product, where the computer program product includes a non-transitory computer readable storage medium that stores a computer program, and the computer program may be operated to enable a terminal device and/or a communications device to perform some or all of the steps in the method in the foregoing aspects. In some implementations, the computer program product may be a software installation package.

According to a twelfth aspect, an embodiment of this application provides a chip, where the chip includes a memory and a processor, and the processor may invoke and run a computer program from the memory, so as to implement some or all of the steps described in the method in the foregoing aspects.

For the same device, certain delays at the transmitting end that affect phase estimation, e.g., hardware delays, remain relatively constant. Therefore, it can be assumed that these delays of the first device remain nearly unchanged between the time of transmitting the first signal and the time of transmitting the second signal. Calculating the phase difference between the first signal and the second signal can eliminate these delays at the transmitting end, thereby making the obtained phase difference not affected by such delays e.g., hardware delays at the transmitting end.

### BRIEF DESCRIPTION OF THE DRAWINGS

FIG. 1 is a schematic diagram of a wireless communication system applied in the embodiments of the present application.

FIG. 2 is a schematic flowchart of a wireless communications method according to embodiments of the present application.

FIG. 3 is a schematic structural diagram of a terminal device according to the embodiments of the present application.

FIG. 4 is a schematic structural diagram of a communications device according to the embodiments of the present application.

FIG. 5 is a schematic structural diagram of a communications device according to the embodiments of the present application.

FIG. 6 is a schematic structural diagram of an apparatus for communication according to the embodiments of the present application.

### DETAILED DESCRIPTION OF THE EMBODIMENTS

The following describes the technical solutions in this application with reference to the drawings.

### Communications System

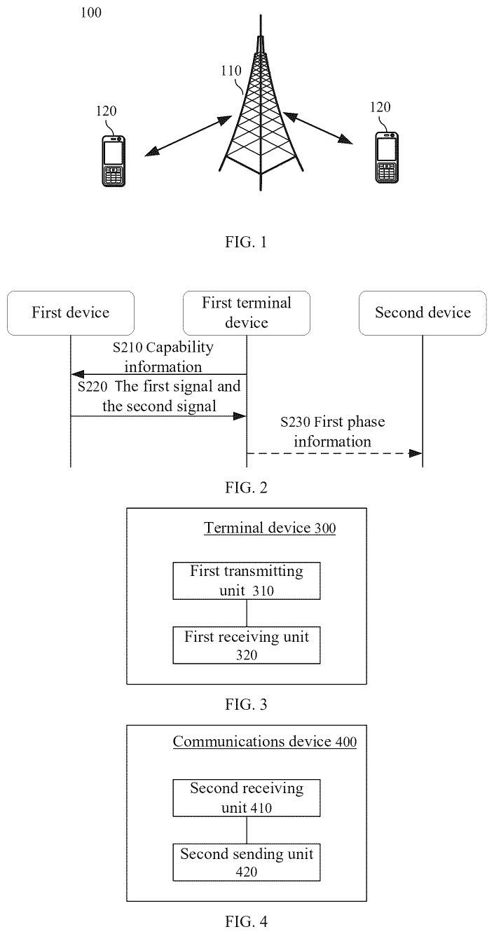

FIG. 1 illustrates a wireless communications system 100 applied to the embodiments of this application. The wireless communications system 100 may include communications devices. The communications devices may include a network device 110 and a terminal device 120. The network device 110 may be a device that communicates with the terminal device 120.

FIG. 1 exemplarily shows one network device and two terminals. Optionally, the wireless communications system 100 may include multiple network devices, and a coverage range of each network device may include another quantity of terminal devices. This is not limited in the embodiments of this application.

Optionally, the wireless communications system 100 may further include another network entity such as a network controller and a mobility management entity. This is not limited in the embodiments of this application.

It should be understood that the technical solutions in the embodiments of this application may be applied to various communications systems, for example, a 5th generation (5G) system or a new radio (NR), a long-term evolution (LTE) system, an LTE frequency division duplex (FDD) system, and an LTE time division duplex (TDD). The technical solutions provided in this application may further be applied to future communications systems, such as a sixth-generation mobile communications system or a satellite communications system.

The terminal device in the embodiments of this application may also be referred to as user equipment (UE), an access terminal, a user unit, a user station, a mobile station, a mobile station (MS), a mobile terminal (MT), a remote station, a remote terminal, a mobile device, a user terminal, a terminal, a wireless communications device, a user agent, or a user apparatus. The terminal device in the embodiments of this application may be a device that provides voice and/or data connectivity to a user, and may be configured to connect a person, a thing, and a machine, for example, a handheld device and an in-vehicle device that have a wireless connection function. The terminal device in the embodiments of this application may be a mobile phone, a Pad, a notebook computer, a laptop computer, a mobile internet device (MID), a wearable device, a virtual reality (VR) device, an augmented reality (AR) device, a wireless terminal in industrial control, a wireless terminal for self-driving, a wireless terminal in a remote medical surgery, a wireless terminal in a smart grid, a wireless terminal in a transportation safety, a wireless terminal in a smart city, a wireless terminal in a smart home, or the like. Optionally, the UE may be configured to serve as a base station. For example, the UE may act as a scheduling entity that provides a sidelink signal between UEs in V2X, D2D, etc. For example, cellular phones and vehicles communicate with each other through side link signals. Cellular phones communicate with smart home devices without having to relay communication signals via base stations.

The network device in the embodiments of this application may be a device for communicating with a terminal device, and the network device may also be referred to as an access network device or a radio access network device. For example, the network device may be a base station. The network device in the embodiments of this application may be a radio access network (RAN) node (or device) that accesses a radio network via a terminal device. The base station may broadly cover various names in or replace with the following names: a NodeB, an evolved NodeB (eNB), a next-generation base station (next generation NodeB, gNB), a relay station, an access point, a transmission point (transmitting and receiving point, TRP), a transmitting point (TP), a master station MeNB, a secondary station SeNB, a multimode radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. The base station may further refer to a communications module, a modem, or a chip that is configured to be disposed in the foregoing device or apparatus. The base station may further be a mobile switching center and a device-to-device (D2D), a vehicle-to-everything (V2X), a device that functions as a base station in machine-to-machine (M2M) communication, a network side device in a 6G network, a device that functions as a base station in a future communications system, or the like. The base station may support a network of a same or different access technologies. The embodiments of the present application do not impose limitations on the specific technologies and specific device forms adopted by the access network device.

The base station may be stationary or mobile. For example, a helicopter or drone may be configured to act as a mobile base station, and one or more cells can move according to the location of the mobile base station. In other examples, a helicopter or drone may be configured as a device for communicating with another base station.

The communications devices involved in the wireless communications system may include not only access network devices and terminal devices but also core network elements. The core network elements may be implemented through devices, i.e., the core network elements are core network devices. It should be understood that core network devices may also be considered as network devices.

The core network elements in the embodiments of the present application may include network elements responsible for processing and forwarding user signaling and data. For example, the core network devices may include a core access and mobility management function (AMF), a session management function (SMF), a user plane gateway, a location management function (LMF), and other core network devices. The user plane gateway may be a server that provides functions such as mobility management, routing, and forwarding of user plane data, and typically located on the network side, such as a serving gateway (SGW), a packet data network gateway (PGW), or a user plane function (UPF). Alternatively, the core network may also include other network elements, which are not exhaustively listed here.

In some deployments, the network device in the embodiments of this application may refer to the CU or DU, or the network device includes a CU and a DU. The gNB may further include an AAU.

The network device and the terminal device may be deployed on land indoors or outdoors, and the network device and the terminal device each may be a handheld or in-vehicle device. The network device and the terminal device may also be deployed on a water surface, on airborne aircraft, balloons and satellites. A scenario in which the network device and the terminal device are located is not limited in the embodiments of this application.

It should be understood that all or a part of functions of the communications device in this application may be implemented by software running on hardware or by a virtualized function instantiated on a platform (e.g., a cloud platform).

### Non-Terrestrial Networks (NTN)

The NTN may provide a communication service to a user in a non-ground mode. That is, an NTN device (for example, a non-ground network device) such as a satellite (satellite, SAT) and a UAS platform may communicate with the terminal device.

For ground network communication, in a scenario such as a sea, a mountain, or a desert, land communication cannot set up a communications device. Alternatively, considering the construction and operation costs of communications equipment, terrestrial communications generally do not cover a sparsely populated area. The NTN has many advantages over terrestrial network communication. First, an NTN communications network is not limited by a region. In theory, satellites can orbit the earth, so every corner of the earth can be covered by satellite communications. In addition, an area that can be covered by the non-terrestrial network device is far greater than an area covered by the terrestrial communications device. That is, the NTN cell can cover a larger range.

Non-terrestrial network devices may move relative to the earth, so in NTN, cells may move on the earth's surface. This phenomenon may make it difficult for the network device to reliably determine a location of the terminal device, or even to determine a country to which the terminal device belongs, which may make it difficult for the NTN to support a surveillance service. Based on this, it is unreliable to rely only on a global navigation satellite system (GNSS) report from a terminal device, and a solution that combines the GNSS report with a network-based solution can improve reliability. Therefore, the network operator should cross-check the location of the terminal device beyond the GNSS location based on satellite navigation as reported by the terminal, thereby meeting potential regulatory requirements.

### Positioning Technologies

As communications technologies become more mature, some communications systems (for example, 5G systems) may implement increasing communications algorithms. These communication algorithms may include information high-rate transmission, positioning technologies, and the like. For example, for the foregoing NTN system, not only positioning of a terminal device may be implemented by using the GNSS, but also positioning of a terminal device may be implemented by using a non-ground communications device such as a satellite by using a communications algorithm, so as to meet a requirement of the NTN system.

Some wireless communications systems may include servers. The solution of the location coordinates of the terminal device may be performed in the server. Such a server may also be referred to as a positioning server.

The positioning server may be a network device that is provided by an operator and has a positioning function. The network device with a positioning function may be a core network device or a cloud server. For example, the positioning server in the embodiments of this application may include one or more of a location management function (LMF), a location management component (LMC), or a local location management function (LLMF) located in the network device. This is not limited in the embodiments of this application.

The positioning system may determine a position of a to-be-positioned object (hereinafter referred to as a target) by a geometric positioning method. The geometric positioning may determine the position of the target based on a distance between the target and the reference point. The distance may be determined based on a sending time of a wireless signal or by an angle between a target and a reference point. For example, a positioning system may calculate a position of a target by a triangle method (or referred to as a triangle measurement) or a polygon method (or referred to as a multilateral measurement). The triangle method is usually implemented by obtaining angles between a target and at least two reference points.

The geometric principles of geometric positioning involve the fundamental concepts of triangulation and polygonal measurement. Triangulation is a method of determining a position by measuring the sides and angles of a triangle. In positioning, it is common to use angle and length information from a triangle for measurements. Polygonal measurement, on the other hand, determines a position by measuring the internal and external angles of a polygon. This method typically requires at least three known reference points, and by measuring the angles between the target and these reference points, the target's position can be calculated. For example, the trilateration method uses three known reference points and measures the distances between the target and these points to compute the target's position. This method is commonly used in wireless positioning and indoor positioning systems.

According to the positioning geometric principle, a user can be located by measuring signals of different transmitters. A position in which different transmitters are located is a position of a reference point. Alternatively, a user can be located based on multiple signals transmitted by a same transmitter. The transmitter may transmit signals at multiple different locations, which may be a position of a reference point. For example, based on a signal sent by the transmitter at a location, a distance between the user and the location may be determined. Based on a signal sent by the transmitter at another location, a distance between the user and this location may be determined. The location of the user can be determined based on distances between the user and multiple locations.

### Antenna Array

The antenna array performs signal transmission or reception by cooperating with multiple antennas. By adjusting the antennas in the antenna array, the antenna array may form a specific geometry in space, such as a linear array, a uniform matrix, and a circular array. The antenna array can improve performance of a communications system by multi-path propagation processing and an anti-interference algorithm. In addition, the antenna array allows multiple independent signals to be transmitted simultaneously at a same frequency, thereby improving spectrum efficiency. The beamforming is used as an example. Based on the beamforming, the antenna array may form a beam in a specific direction by adjusting a phase and an amplitude of each antenna, thereby increasing system sensitivity to a specific direction and reducing interference to another direction. In radar and sensor applications, antenna arrays can be beamformed to achieve high resolution target detection and tracking.

The antenna array can be adjusted according to specific application requirements, providing greater flexibility. In communications systems, antenna arrays can be used in multiple input multiple output (MIMO) systems (also referred to as multi-antenna systems) to enhance data transmission rates and system reliability. In radar systems, antenna arrays can be utilized to implement phased array radar, offering advantages such as fast scanning, target tracking, and anti-interference capabilities. In wireless sensor networks, antenna arrays can be applied in positioning, directional transmission, and energy focusing.

In summary, antenna arrays represent a powerful technology widely used in wireless communication, radar, sensing, and other wireless application fields.

### Phase Estimation

During positioning, measuring the phase information of the received signal enables more accurate determination of the distance between the transmitting end and the receiving end. Phase information can be obtained through phase estimation. However, due to various factors, the phase of the signal may be affected by noise, leading to uncertainty in phase estimation.

For an NTN system, the factors affecting the phase estimation of signals transmitted by NTN devices may originate from one or more of the following: the transmission environment, the receiving system, and the NTN device itself. The following explanation takes an NTN device in the form of a satellite as an example.

The transmission environment of satellite signals includes the Earth's atmosphere. The ionosphere and troposphere within the atmosphere can cause refraction and variations in the transmission speed of electromagnetic waves, thereby affecting the signal phase. These atmospheric effects are commonly referred to as atmospheric delays, which constitute a significant source of phase estimation errors in certain navigation systems (such as the global positioning system (GPS) and BeiDou navigation satellite system (BDS)).

The multipath effect occurs when signals transmit along multiple paths before reaching the receiving device (also referred to as the receiving station, receiver, or receiving end), resulting in multiple versions of the signal arriving simultaneously and causing phase distortion. The multipath effect impacts accuracy of the phase estimation.

Clock errors at the receiving end can also influence phase estimation. Even if the clock at the receiving end is highly accurate, clock discrepancies may still arise due to factors (such as temperature variations and clock drift).

In satellite systems, hardware-induced delays from components (such as antennas, amplifiers, mixers, and transmission lines) also affect phase estimation.

Satellite motion induces the Doppler effect, which causes frequency shifts in the received signal and, in turn, impacts the accuracy of phase estimation.

The calibration accuracy of signal receiving device directly affects precision of phase estimation. The calibration quality of each component in the signal receiving device affects the phase of the signal.

The aforementioned factors contribute to errors in phase estimation. Therefore, in satellite communication, navigation, and related applications, various techniques, such as differential techniques and beamforming, are employed to mitigate these errors.

Differential techniques are widely used to reduce or eliminate common errors, including atmospheric delays, particularly in satellite navigation systems and other high-precision phase measurement applications.

Phase differential techniques can be categorized into single-point phase differential and double-point phase differential.

The single-point phase differential can eliminate certain errors between two receiving stations (a reference receiver and a primary receiver) by a reference receiver within the receiving station. The reference receiver is typically assumed to be unaffected by errors such as atmospheric delays, making its observations useful for calibrating the primary receiver's observations. By computing the difference between the primary receiver's observation data and the reference receiver's observation data, common errors such as atmospheric delays and receiver clock offsets can be mitigated. The single-point phase differential is generally applicable to applications within a relatively short distance range.

Double-point phase differential takes into account the differences between two receiving stations, allowing spatial variations to be used for calibrating errors such as atmospheric delays. This technique is typically applied to two relatively distant receiving stations. Since double-point phase differential considers spatial variations rather than just single-point calibration, it can achieve higher accuracy.

Through differential techniques, errors such as atmospheric delays can be mitigated to a certain extent, thereby improving the accuracy of phase measurements. This has significant applications in high-precision satellite navigation, Earth observation, and scientific research.

As demonstrated by differential techniques, the receiving end can perform phase estimation on signals from different satellites and compute the phase difference to eliminate errors caused by receiver clock offsets, receiver hardware delays, and atmospheric effects. However, these techniques primarily address receiver-side errors and cannot eliminate the impact of satellite clock offsets, initial satellite phase, or satellite hardware delays on phase measurements.

Therefore, existing technologies struggle to eliminate the influence of the transmitting end on phase measurement. For example, it remains challenging to remove errors introduced by clock offsets, hardware delays, and initial phase at the transmitting end, making it difficult to achieve highly accurate phase measurement results.

FIG. 2 is a schematic flowchart of a wireless communications method according to an embodiment of this application, to resolve the foregoing problem.

The method shown in FIG. 2 may be executed by a first terminal device and a first device. The first device may be a mobile device. For example, the first device is an NTN device. For example, the first device may include a satellite. It should be noted that the mobile device may be a device that moves relative to the ground or the earth.

The method shown in FIG. 2 may include the following step S210 to step S220.

In step S210, the first terminal device transmits capability information to the first device.

In some embodiments, the first device may determine, according to the capability information of the first terminal device, whether to perform step S220.

In step S220, the first device transmits the first signal and the second signal to the first terminal device.

A location at which the first device sends the first signal may be a first location, and a location at which the first signal sends the second signal may be a second location. The first location may be different from the second location. That is, the first signal and the second signal may be sent at different locations by a same transmitting end.

It should be noted that a difference between the first location and the second location may refer to: sing the ground or the earth as a reference, where the two locations are different. That is, the first device moves relative to the ground.

In some embodiments, the first signal is sent at a first moment, and the second signal is sent at a second moment. The first moment is different from the second moment. That is, a sending moment of the first signal is different from a sending moment of the second signal. The first device may move. Therefore, in a case in which a sending moment of the first signal and a sending moment of the second signal are different, respective locations at which the first device sends the first signal and the second signal are also different.

It should be noted that a sending sequence of the first signal and the second signal is not limited in this application. For example, the first signal may be sent earlier or later than the second signal. That is, the first moment may be earlier than the second moment, or may be later than the second moment.

The first signal and/or the second signal may be signals that can be used for performing phase estimation. For example, the first signal and/or the second signal may include a positioning signal. The positioning signal may be, for example, a positioning reference signal (PRS). For example, the first signal may include a first PRS. For another example, the second signal may include a second PRS.

In some embodiments, the first device may send multiple signals, and the multiple signals may include a first signal and a second signal. For example, the first signal and the second signal may be two adjacent signals in the multiple signals. Alternatively, there is at least one signal between the first signal and the second signal. The multiple signals may be periodically sent, that is, adjacent signals in the multiple signals may be sent at equal intervals. Multiple signals may also be sent aperiodically.

The first signal and the second signal may be used to determine the first phase information. The first phase information may include a phase difference between the first signal and the second signal.

It should be noted that the first phase information may include the phase difference between the first signal and the second signal at the receiving end. In other words, this phase difference can be obtained based on the detection of the first signal and/or the second signal received by the first terminal device. Therefore, in some embodiments, this phase difference may also be referred to as the received phase difference.

Exemplarily, the first terminal device can detect the first signal and the second signal to perform phase estimation. For example, the first terminal device can determine phase information based on the time of arrival of the first signal and/or the second signal at the first terminal device. Specifically, the first terminal device can obtain the phase information of the first signal. Similarly, the first terminal device can obtain the phase information of the second signal. The phase information may include the detected phase of the corresponding signal. By computing the difference between the phase of the first signal and the phase of the second signal, the phase difference between the two signals can be obtained.

It should be noted that the phase difference between the first signal and the second signal may include: a phase of the first signal minus a phase of the second signal, or a phase of the second signal minus the phase of the first signal. This application imposes no limitation thereto.

It should be noted that the phase of the first signal or the second signal can be used as a reference phase to calculate the phase difference. In other words, for any of the multiple signals received by the first terminal device, the phase difference between the corresponding signal and the reference phase can be calculated using the reference phase. The reference phase or the signal corresponding to the reference phase can be determined either by the first terminal device or by a network device.

It can be understood that the first phase information proposed in this application may include the phase differences between multiple signals transmitted by the same transmitting end at different positions. Since the transmitting end is the same device, the phase difference obtained based on this application will not be affected by the delays at the transmitting end, thus enabling accurate measurement. Below, an analysis and explanation of how this application eliminates hardware delay errors is provided using the example of a first device, e.g., a satellite.

For different satellites, there are hardware differences, so the hardware delay errors between different satellites also vary. If the hardware delay errors are not accurately compensated or corrected, the calculated phase difference will introduce corresponding errors, thus affecting the accuracy of the measurement results. In the related technology, precise clock synchronization and other measures can be used to minimize the impact of hardware delay errors. However, since the clocks of different satellites are difficult to fully synchronize, some residual hardware delay errors may still exist.

For the same satellite, the hardware delay is usually relatively constant because it is primarily caused by the signal transmission and processing time, and these factors are unlikely to change significantly over short periods of time. Below is an explanation using examples of transmission delay, signal processing delay, storage delay, and other hardware delays. The transmission delay refers to the time it takes for the signal to travel from the ground station to the satellite and then return to the ground station. This mainly depends on the speed of signal transmission, which is the speed at which electromagnetic waves travel through space. Since the speed of light is a constant and does not vary with time, the transmission delay is relatively stable. The signal processing delay refers to the time required for signal processing on the satellite. Signal processing can include decoding, processing sensor data, executing instructions, and so on. It can be understood that signal processing delay is usually relatively constant, changing only when hardware or software upgrades or modifications occur on the satellite. The storage delay refers to the time the signal spends waiting for processing in storage if there are storage devices on the satellite. The storage delay is also generally stable, unless there is a change in the storage medium or storage system.

For the same device, some delays, such as hardware delays, at the transmitting end that affect phase estimation are relatively constant. Therefore, it can be assumed that these delays of the first device remain nearly unchanged at the moment of sending the first signal and the moment of sending the second signal. When calculating the phase difference between the first and second signals, the part influenced by delays at the transmitting end can be eliminated, so that the obtained phase difference is not affected by delays such as the hardware delay at the transmitting end.

In particular, in complex environments, the errors caused by hardware delays become more apparent. Therefore, this application not only allows for accurate modeling and correction of hardware delay errors to achieve high-precision measurements, but can also obtain relatively accurate measurement results in complex environments. In other words, this application can also be applied in high-precision measurement applications.

Additionally, the first device can create an equivalent antenna array through movement, meaning the first and second signals can be sent by different antennas in the equivalent antenna array. It can also be stated that for the same antenna, by transmitting signals from different positions, cooperative operation of the same antenna at different locations can be realized, forming an equivalent antenna array. By constructing an equivalent antenna array, technologies based on antenna arrays (such as beamforming) can be utilized to improve the performance of the communications system.

In some embodiments, the position of the first terminal device can be calculated based on the first phase information.

In step S210, the capability information reported by the first terminal device can indicate whether the first terminal device supports calculating the phase difference between the first signal and the second signal. In other words, the first terminal device can report whether it supports calculating the phase difference of different signals from the same device.

Optionally, when the moving speed of the first terminal device is less than or equal to a first speed threshold, the first terminal device can support calculating the received phase difference between the first signal and the second signal; and/or, when the moving speed of the first terminal device is greater than the first speed threshold, the first terminal device may not support calculating the received phase difference between the first signal and the second signal. The first speed threshold is a positive value. In other words, when the first terminal device is not moving at a high speed, the first terminal device can support calculating the received phase difference between the first and second signals.

When the first terminal device is moving at high speed, a significant change in the user's position occurs when the first terminal device detects the first and second signals. In situations where the position changes greatly, the scattering environment around the first terminal device changes significantly as well. As a result, the correlation between the phase of the first signal received and the phase of the second signal received is low. Even if a phase difference is obtained, that phase difference cannot reflect the distance difference between the first terminal device and the first device, leading to the phase difference being unsuitable for distance estimation and, consequently, unusable for estimating the position of the first terminal device.

In some embodiments, the first terminal device may receive first information. The first information can be sent by the first device. The following explains the first information.

In some embodiments, the first information can configure the first signal and/or the second signal. In this case, the first information may configure one or more of the following: the transmitting time of the first signal, the receiving time of the first signal, the transmitting time of the second signal, the receiving time of the second signal, the identifier of the first signal, or the identifier of the second signal.

When the first signal and the second signal are of the same type, for example, when both the first signal and the second signal are PRS signals, the first information can be used to configure the transmitting time and/or the receiving time of that type of signal. For example, the first information can be used to configure the transmitting time and/or receiving time of multiple PRS signals.

In some embodiments, the receiving time can also be referred to as the detection timestamp. That is, the receiving time of the first signal can be called the detection timestamp of the first signal, and the receiving time of the second signal can be called the detection timestamp of the second signal.

As mentioned above, the first signal and the second signal can belong to multiple signals sent periodically. In this case, the first information can indicate the transmission period of the multiple signals. For example, the transmission period can include the transmission interval and/or the transmission offset.

Based on the first information, the first terminal device can receive and detect the first signal and/or the second signal. In other words, based on the first information, the first terminal device can perform step S220.

It should be noted that the sending moment or the receiving moment in this application may be represented by one or more of the following: an absolute time or a first time unit. The absolute time may be, for example, world time. For example, the first information may indicate that the sending time of the first signal is Dec. 19, 2023, at 14:01:23.01 microseconds. The absolute time may be included in the first information in the form of a timestamp. The first time unit may include one or more of the following: a frame, a subframe, or an orthogonal frequency division multiplexing (OFDM) symbol. For instance, the first information may indicate one or more of a frame number, a subframe number, or an OFDM symbol index for the sending time of the second signal.

In some implementations, the first information may indicate whether the first terminal device needs to calculate the phase difference between the first signal and the second signal.

In some implementations, the first information may indicate whether the multiple signals sent by the first device support phase estimation. For example, the multiple signals may be used for positioning, and the first information may indicate whether the signals used for positioning sent by the first device support phase estimation.

In some implementations, the first information may indicate whether the first signal and the second signal support the phase estimation for calculating a difference.

In some embodiments, the first terminal device may determine the first phase information. In some embodiments, the first terminal device may send the phase information of the first signal and the phase information of the second signal to another device (for example, the second device described below), so that the another device determines the first phase information.

The phase difference between the first signal and the second signal may be used to implement positioning of the first terminal device. In a case in which the first terminal device determines the first phase information by itself, the first terminal device may determine the location of the first terminal device by itself according to the first phase information. The first terminal device may send the first phase information to another device, so that the another device solves the location of the first terminal device.

In some embodiments, the method shown in FIG. 2 may further include a step S230, which may be performed by the first terminal device and the second device.

In step S230, the first terminal device sends one or more of the first phase information, the phase information of the first signal, or the phase information of the second signal to the second device.

In some embodiments, the second device may include a destination, that is, a final receiver of a signal. In some embodiments, the second device may include a forwarding device (or a relay device). For example, the second device may forward the received first phase information to another device.

The second device may include one or more of the following: a positioning solution unit, a positioning server, a second terminal device that serves as a central node, or a first base station.

The positioning solution unit may participate in positioning of the first terminal device. The output of the positioning solution unit may include one or more of the following: a location of the first terminal device or intermediate data of for resolving the location of the first terminal device. The intermediate data may include a distance, an angle, and the like between the first terminal device and the first device. The positioning solution unit may be any device that participates in positioning of the first terminal device. For example, the positioning solution unit may be one or more of the following: a first terminal device, a first device, a second device, a positioning server, a base station, a core network device, or a second terminal device.

In a case in which the second device includes a positioning solution unit, the positioning solution unit may determine the first phase information according to the phase information of the first signal and the phase information of the second signal, and/or the positioning solution unit may calculate the location of the first terminal device based on the first phase information.

In a case in which the second device includes the positioning server, the positioning server may determine the first phase information according to the phase information of the first signal and the phase information of the second signal, and/or the positioning server may calculate the location of the first terminal device based on the first phase information.

In a case in which the second device includes the second terminal device that serves as the central node, the second terminal device may determine the first phase information according to the phase information of the first signal and the phase information of the second signal, and/or the second terminal device may calculate the location of the first terminal device based on the first phase information.

In a case in which the second device includes the first base station, the first base station may determine the first phase information according to the phase information of the first signal and the phase information of the second signal, and/or the first base station may calculate the location of the first terminal device based on the first phase information.

The first base station may include a serving base station and/or a neighboring base station (or a neighboring transmission point) of the first terminal device. That is, the first terminal device may communicate with the serving base station and/or the neighboring base station. For example, in a case in which the first terminal device is located within coverage of the serving base station, the second device may include the serving base station. In a case in which the first terminal device moves out of coverage of the serving base station, the second device may include the neighboring base station. For example, when the first terminal device is in a radio resource control (RRC) inactive state or an RRC idle state, the first terminal device may move out of coverage of the serving base station.

Optionally, in a case in which the second device includes a neighboring base station, the first terminal device may transmit a signal (for example, first phase information) through an uplink grant (UL grant) allocated by the serving base station.

The uplink grant allocated by the serving base station may be indicated by the second information. That is, the serving base station may send the second information to the neighboring base station. The second information may indicate a detection related parameter such as an uplink grant time-frequency code. For example, the serving base station may send the second information to all neighboring base stations that can detect the uplink grant.

Optionally, in a case in which the second device includes the neighboring base station, the first terminal device may transmit a signal (for example, the first phase information) to the neighboring base station through the first resource. The first resource may be a resource shared by the serving base station and the neighboring base station.

The neighboring base station and the serving base station may belong to multiple base stations. Resources shared by multiple base stations may form a shared resource pool. The first resource may be obtained from the shared resource pool. For example, the first resource may be obtained from the shared resource pool in a scheduling-free manner.

In some embodiments, the first phase information may be used to calculate a location of the first terminal device. That is, the location of the first terminal device may be calculated based on the phase difference between the multiple signals sent by the first device. The location solution may be implemented by geometric positioning.

In related technologies, if the first device moves, there may be some errors in determining the location of the first terminal device based on signals sent by the first device. Taking the example where the first device is a satellite, determining the position of the first terminal device requires knowing the position of the satellite. The related technology can determine the satellite's sending time based on the receiving time of the positioning signal and the approximate distance between the first terminal device and the satellite, thereby determining the satellite's position. However, due to the high-speed movement of the satellite, determining the satellite's sending time based on the approximate distance between the terminal device and the satellite introduces errors, which may lead to deviations in the satellite position estimation and consequently result in location errors for the first terminal device. In contrast, this application considers the phase difference when determining the satellite's position. The corresponding time difference is determined based on the phase difference, and then the satellite's movement distance can be obtained. Incorporating the satellite's movement distance can improve the positioning accuracy of the first terminal device.

Optionally, the location of the first terminal device may be determined based on one or more of the following: the first phase information, information about the first device, information about the first terminal device, a first location, a second location, or the like.

The information about the first device may include one or more of the following: a running track of the first device, ephemeris information of the first device, a moment at which the first device sends the first signal, a moment at which the first device sends the second signal, or an identifier of the first device. The running track may include an actual running track and/or an equivalent running track.

The information about the first terminal device may include one or more of the following: a moment at which the first terminal device receives the first signal or a moment at which the first terminal device receives the second signal. A moment at which a signal is received may be represented by a timestamp.

It should be noted that when the second device solves the location of the first terminal device, the first device and/or the first terminal device need to send the information about the first device to the second device if the module used for the location calculation is not on the first device (that is, the first device is different from the second device).

In some embodiments, the first phase information may be used to solve the first location and the second location. The first location and the second location may be resolved based on one or more of the following: the first information, information about the first device, third information, information about the first terminal device, or clock-related information.

The third information may indicate a correspondence between the first phase information and a location (including the first location and the second location) of the first device. For example, the third information may indicate one or more of the following: a relationship between the first phase information and the first signal, a relationship between the first phase information and the second signal, or a relationship between the first phase information and the first device. The relationship between the first phase information and the first signal may be indicated by an identifier (ID) of the first signal. Similarly, the relationship between the first phase information and the second signal may be indicated by an ID of the second signal. That is, the third information may indicate that the first phase information is determined based on a signal of which two IDs. Therefore, the first location may be determined based on the identifier of the first signal, and the second location may be determined based on the identifier of the second signal. For example, both the first signal and the second signal are PRSs, and PRSs sent at different moments may have different PRS IDs. The relationship between the first phase information and the first device may be indicated by an ID of the first device. For example, in a case in which the first device is a satellite, the correspondence may be determined based on an ID of the satellite. That is, the third information may indicate that the first phase information is determined based on information sent by a device of a specific ID.

It may be understood that, a location of the first terminal device may be resolved based on the correspondence indicated by the third information.

The following uses an example in which both the first signal and the second signal are PRSs as an example to describe determining of the first position and the second position. The first terminal device may report the PRS ID corresponding to the first phase information. Based on the PRS ID, the second device may determine a location (including the first location and/or the second location) at which the first device sends the PRS.

Taking the first signal as the first PRS, the second signal as the second PRS, and the first device as a satellite as an example, the method for determining the first position and the second position can be illustrated through Steps 1 to 3. In step 1, the receiving time of the first PRS is determined according to the configuration ID of the first PRS, and the receiving time of the second PRS is determined according to the configuration ID of the second PRS. In step 2, the approximate sending time of the first PRS and the second PRS is determined according to the receiving time of the first PRS, the receiving time of the second PRS and the approximate distance between the first terminal device and the satellite. In step 3, the first position is determined according to the sending time of the first PRS combined with the ephemeris information, and the second position is determined according to the sending time of the second PRS combined with the ephemeris information.

The clock-related information may also be referred to as detection timestamp-related information. The clock-related information may include information about a time difference between a clock of the first terminal device and a reference clock.

The first terminal device may report one or more pieces of the above information to the second device so that the second device can solve one or more of pieces of information about the first terminal device, the first position, or the second position. For example, the first terminal device sends the third information to the second device. The following takes the first device as a satellite, the first signal and the second signal as PRSs as an example to illustrate the information reported by the first terminal device to the second device.

For example, the first terminal device may report the detected phase information, the satellite ID corresponding to the phase information, and the first information.

For another example, the first terminal device may report the detected phase information, the satellite ID corresponding to the phase information, and the PRS detection timestamp. The PRS detection timestamp can be used to determine the location of the satellite when sending the PRS.

For another example, the first terminal device may report the detected phase information, the satellite ID corresponding to the phase information, the PRS detection timestamp, and the detection timestamp related information.

For another example, the first terminal device may report the phase difference between the first signal and the second signal.

In some embodiments, the transmission interval between the first signal and the second signal may be greater than a threshold. The threshold may be related to one or more of the following: the transmission delay between the first terminal device and the first device, or the processing delay of the first terminal device.

In the case where the first signal and the second signal belong to multiple periodically transmitted signals, the transmission interval (referred to as the periodic interval) between any two adjacent signals in the multiple signals may be greater than the threshold.

It can be understood that for multiple periodically transmitted signals, the first position and/or the second position of the first device can be determined according to a non-periodic scenario when the periodic interval is greater than the threshold.

In an actual communications system, the first signal and the second signal may use different frequencies. Alternatively, due to the influence of the transmission scenario, the frequencies of the first signal and the second signal may be different. Taking the example where the first device includes a satellite, the signals received by the first terminal device are affected by Doppler frequency shift due to the high-speed movement of the satellite. This Doppler frequency shift may cause the first terminal device to receive the first signal and the second signal at different frequencies.

The present application proposes a method for calculating the phase difference.

In some embodiments, the phase difference Δø may satisfy:

$$Δ∅ = \frac{{f}_{2} {∅}_{1}}{{f}_{1}} - {∅}_{2} .$$

f₁ may represent the receiving frequency of one of the two signals (e.g., the first signal) for calculating the phase difference, f₂ may represent the receiving frequency of the other of the two signals (e.g., the second signal) for calculating the phase difference, Ø₁ may represent the phase measured by the first terminal device for one signal (e.g., the first signal), and Ø₂ may represent the phase measured by the first terminal device for the other signal (e.g., the second signal).

It should be noted that the receiving frequency may represent the frequency of the signal received by the first terminal device. Alternatively, the receiving frequency may represent the frequency of the corresponding signal detected by the first terminal device.

In some embodiments, the transmission frequency of the first signal is different from the transmission frequency of the second signal, that is, f₁ is different from f₂. The transmission frequency may represent the frequency of the signal when the first device transmits the signal. In some embodiments, the receiving frequency may be affected by Doppler frequency shift. For example, the transmission frequency of the first signal and the transmission frequency of the second signal may be the same. Since the first signal and/or the second signal are affected by Doppler frequency shift during transmission, f₁ is different from f₂.

It should be noted that f₁ may be the same as f₂. In this case, Δø may satisfy: Δø=ø₁−ø₂. That is, the phase difference is equal to the difference between the phase of one detected signal and the phase of another detected signal.

It should be noted that, in some implementations, the method for calculating the phase difference proposed in this application can be used to calculate the phase difference between different signals sent by the same transmitter. In some implementations, the method for calculating the phase difference proposed in this application can be used to calculate the phase difference between signals sent by different transmitters.

The method for calculating the phase difference is described below through the first embodiment. The method provided in the first embodiment may include steps 1 to 3. The method may be performed by the first device and the first terminal device.

In step 1, the first device sends a first signal and a second signal to the first terminal device. The description of the first signal and the second signal is as described above. That is, the first signal and the second signal can be sent by the same transmitting end. Alternatively, the first signal and the second signal can be different from those described above. For example, the first signal and the second signal are sent by different transmitting ends.

In step 2, the first terminal device detects the first signal and the second signal. Through step 2, the first terminal device can detect the phase Ø₁ and frequency f₁ of the first signal, and the phase Ø₂ and frequency f₂ of the second signal.

In step 3, the first terminal device calculates the received phase difference according to the phase Ø₁ of the first signal, the frequency f₁ of the first signal, the phase Ø₂ of the second signal, and the frequency f₂ of the second signal. The received phase difference Δø may satisfy:

$$Δ∅ = \frac{{f}_{2} {∅}_{1}}{{f}_{1}} - {∅}_{2} .$$

The method embodiments of the present application are described in detail above, and the device embodiments of the present application will be described in detail below. It should be understood that the description of the method embodiments corresponds to the description of the device embodiments, so the part not described in detail can refer to the previous method embodiments.

FIG. 3 is a schematic structural diagram showing a terminal device 300 according to an embodiment of the present application. The terminal device 300 is a first terminal device. The terminal device 300 includes: a first transmitting unit 310 and a first receiving unit 320.

The first transmitting unit 310 is configured to transmit capability information. The first receiving unit 320 is configured to receive a first signal and a second signal sent by a first device. The first signal and the second signal are used to determine the first phase information. The first phase information includes a phase difference between the first signal and the second signal. The location where the first device sends the first signal is the first location, and the location where the first device sends the second signal is the second location, and the first position is different from the second position.

In some embodiments, the capability information indicates whether the first terminal device supports calculating the phase difference between the first signal and the second signal.

In some embodiments, the terminal device 300 is also configured to: receive the first information. The first information is used to perform one or more of the following: configuring the first signal and the second signal; indicating whether the first terminal device needs to calculate the phase difference between the first signal and the second signal; indicating whether the multiple signals sent by the first device support phase estimation for calculating a difference; or indicating whether the first signal and the second signal support phase estimation for difference calculation for calculating a difference.

In some embodiments, the first information is used to configure one or more of the following: the sending time of the first signal; the receiving time of the first signal; the sending time of the second signal; or the receiving time of the second signal.

In some embodiments, the sending time or the receiving time is represented by one or more of the following: an absolute time or a first time unit.

In some embodiments, the first time unit includes one or more of the following: a frame, a subframe, or an OFDM symbol.

In some embodiments, the terminal device 300 is also configured to: send the first phase information to the second device.

In some embodiments, the second device includes one or more of the following: a positioning solution unit; a positioning server; a second terminal device as a central node; or a first base station. The first base station includes a serving base station and/or a neighboring base station of the first terminal device.

In some embodiments, when the first terminal device moves out of the coverage of the serving base station, the second device includes a neighboring base station, and the first phase information is transmitted through the uplink grant allocated by the serving base station.

In some embodiments, the uplink grant allocated by the serving base station is indicated by the second information, and the second information is transmitted by the serving base station to the neighboring base station.

In some embodiments, when the first terminal device moves out of the coverage of the serving base station, the second device includes a neighboring base station, and the first phase information is transmitted through the first resource shared by the serving base station and the neighboring base station.

In some embodiments, the first resource is obtained from a shared resource pool of the serving base station and the neighboring base station in a scheduling-free manner.

In some embodiments, the first phase information is used to solve the position of the first terminal device.

In some embodiments, the first phase information is used to solve the first position and the second position.

In some embodiments, the first position and the second position are also solved based on the information about the first device.

In some embodiments, the information about the first device includes one or more of the following: a running track of the first device; ephemeris information of the first device; a time when the first device sends the first signal; or a time when the first device sends the second signal.

In some embodiments, the terminal device 300 is also configured to: send third information to the second device. The third information indicates one or more of the following: a relationship between the first phase information and the first signal; or a relationship between the first phase information and the second signal.

In some embodiments, the transmission interval between the first signal and the second signal is greater than a threshold, and the threshold is related to one or more of the following: the transmission delay between the first terminal device and the first device; or the processing delay of the first terminal device.

In some embodiments, the first signal includes a first PRS; and/or, the second signal includes a second PRS.

In some embodiments, the first device includes an NTN device.

In some embodiments, phase difference ΔØ between the first signal and the second signal meets

$$Δ∅ = \frac{{f}_{2} {∅}_{1}}{{f}_{1}} - {∅}_{2} .$$

f₁ represents a receiving frequency of the first signal, f₂ represents a receiving frequency of the second signal, Ø₁ represents a phase obtained by the first terminal device measuring the first signal, and Ø₂ represents a phase obtained by the first terminal device measuring the second signal.

In some embodiments, the receiving frequency is affected by the Doppler frequency shift.

In an optional embodiment, both the first transmitting unit 310 and the first receiving unit 320 can be a transceiver 630. The terminal device 300 can also include a processor 610 and a memory 620, as shown in FIG. 6.

FIG. 4 is a schematic structural diagram showing a communications device 400 according to an embodiment of the present application. The communications device 400 is a first device. The communications device 400 includes: a second receiving unit 410 and a second transmitting unit 420.

The second receiving unit 410 is configured to receive capability information sent by the first terminal device. The second transmitting unit is configured to send a first signal and a second signal to the first terminal device. The first signal and the second signal are used to determine first phase information which comprises a phase difference between the first signal and the second signal, a location at which the first device transmits the first signal is a first location, a location at which the first device transmits the second signal is a second location, and the first location is different from the second location.

In some embodiments, the capability information indicates whether the first terminal device supports calculating the phase difference between the first signal and the second signal.

In some embodiments, the communications device 400 is also configured to: send first information to the first terminal device. The first information is used to perform one or more of the following: configuring the first signal and the second signal; indicating whether the first terminal device needs to calculate the phase difference between the first signal and the second signal; indicating whether the multiple signals sent by the first device support phase estimation for calculating a difference; or indicating whether the first signal and the second signal support phase estimation for difference calculation for calculating a difference.

In some embodiments, the first information is used to configure one or more of the following: the sending time of the first signal; the receiving time of the first signal; the sending time of the second signal; or the receiving time of the second signal.

In some embodiments, the sending time or the receiving time is represented by one or more of the following: an absolute time; or a first time unit.

In some embodiments, the first time unit includes one or more of the following: a frame, a subframe, or an OFDM symbol.

In some embodiments, the first phase information is used to solve the position of the first terminal device.

In some embodiments, the first phase information is used to solve the first position and the second position.

In some embodiments, the first position and the second position are also solved based on the information about the first device.

In some embodiments, the information about the first device includes one or more of the following: a running track of the first device; ephemeris information of the first device; a time when the first device sends the first signal; or a time when the first device sends the second signal.

In some embodiments, the transmission interval between the first signal and the second signal is greater than a threshold, and the threshold is related to one or more of the following: the transmission delay between the first terminal device and the first device; or the processing delay of the first terminal device.

In some embodiments, the first signal includes a first PRS; and/or, the second signal includes a second PRS.

In some embodiments, the first device includes an NTN device.

In some embodiments, phase difference ΔØ between the first signal and the second signal meets

$$Δ∅ = \frac{{f}_{2} {∅}_{1}}{{f}_{1}} - {∅}_{2} .$$

f₁ represents a receiving frequency of the first signal, f₂ represents a receiving frequency of the second signal, Ø₁ represents a phase obtained by the first terminal device measuring the first signal, and Ø₂ represents a phase obtained by the first terminal device measuring the second signal.

In some embodiments, the receiving frequency is affected by the Doppler frequency shift.

In an optional embodiment, the second sending unit 420 and the second receiving unit 410 can both be transceivers 630. The communications device 400 can also include a processor 610 and a memory 620, as shown in FIG. 6.

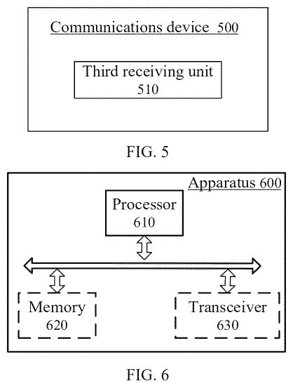

FIG. 5 is a schematic structural diagram showing a communications device 500 according to an embodiment of the present application. The communications device 500 is a second device. The communications device 500 includes: a third receiving unit 510.

The third receiving unit 510 is configured to receive first phase information sent by the first terminal device. The first phase information is determined based on the first signal and the second signal. The first phase information includes a phase difference between the first signal and the second signal. The first signal and the second signal are both sent by the first device. The position where the first device sends the first signal is the first position. The position where the first device sends the second signal is the second position. The first position is different from the second position.

In some embodiments, the second device includes one or more of the following: a positioning solution unit; a positioning server; a second terminal device as a central node; or a first base station. The first base station includes a serving base station and/or a neighboring base station of the first terminal device.

In some embodiments, when the first terminal device moves out of the coverage of the serving base station, the second device includes a neighboring base station, and the first phase information is transmitted through uplink grant allocated by the serving base station.

In some embodiments, the uplink grant allocated by the serving base station is indicated by the second information, and the second information is transmitted by the serving base station to the neighboring base station.

In some embodiments, when the first terminal device moves out of the coverage of the serving base station, the second device includes a neighboring base station, and the first phase information is transmitted through the first resource shared by the serving base station and the neighboring base station.

In some embodiments, the first resource is obtained from a shared resource pool of the serving base station and the neighboring base station in a scheduling-free manner.

In some embodiments, the first phase information is used to solve the position of the first terminal device.

In some embodiments, the first phase information is used to solve the first position and the second position.

In some embodiments, the first position and the second position are also solved based on the information about the first device.

In some embodiments, the information about the first device includes one or more of the following: a running track of the first device; ephemeris information of the first device; a time when the first device sends the first signal; or a time when the first device sends the second signal.

In some embodiments, the communications device 500 is further configured to: receive third information sent by the first terminal device. The third information indicates one or more of the following: a relationship between the first phase information and the first signal; or a relationship between the first phase information and the second signal.

In some embodiments, the transmission interval between the first signal and the second signal is greater than a threshold, and the threshold is related to one or more of the following: the transmission delay between the first terminal device and the first device; or the processing delay of the first terminal device.

In some embodiments, the first signal includes a first PRS; and/or, the second signal includes a second PRS.

In some embodiments, the first device includes an NTN device.

In some embodiments, phase difference ΔØ between the first signal and the second signal meets

$$Δ∅ = \frac{{f}_{2} {∅}_{1}}{{f}_{1}} - {∅}_{2} .$$

f₁ represents a receiving frequency of the first signal, f₂ represents a receiving frequency of the second signal, Ø₁ represents a phase obtained by the first terminal device measuring the first signal, and Ø₂ represents a phase obtained by the first terminal device measuring the second signal.

In some embodiments, the receiving frequency is affected by the Doppler frequency shift.

In an optional embodiment, the third receiving unit 510 may be a transceiver 630. The communications device 500 may also include a processor 610 and a memory 620, as shown in FIG. 6.

FIG. 6 is a schematic structural diagram showing an apparatus for communications in an embodiment of the present application. The dotted line in FIG. 6 indicates that the unit or module is optional. The apparatus 600 may be configured to implement the method described in the above method embodiments. The apparatus 600 may be a chip, a terminal device, or a network device.

The apparatus 600 may include one or more processors 610. The processor 610 may support the apparatus 600 to implement the method described in the method embodiments described above. The processor 610 may be a general-purpose processor or a special-purpose processor. For example, the processor may be a central processing unit (CPU). Alternatively, the processor may also be other general-purpose processors, digital signal processors (DSP), application specific integrated circuits (ASIC), field programmable gate arrays (FPGA) or other programmable logic devices, discrete gates or transistor logic devices, discrete hardware components, etc. A general-purpose processor may be a microprocessor or the processor may also be any conventional processor, etc.

The apparatus 600 may also include one or more memories 620. The memory 620 stores a program, which is executable by the processor 610 so that the processor 610 executes the method described in the method embodiments described above. The memory 620 may be independent of the processor 610 or may be integrated in the processor 610.

The apparatus 600 may also include a transceiver 630. The processor 610 may communicate with other devices or chips through the transceiver 630. For example, the processor 610 may exchange data with other devices or chips through the transceiver 630.

The embodiment of the present application also provides a computer-readable storage medium for storing a program. The computer-readable storage medium can be applied to the terminal or network device according to the embodiments of the present application, and the program enables the computer to execute the method executed by the terminal or network device in the embodiments of the present application.

The embodiment of the present application also provides a computer program product. The computer program product includes a program. The computer program product can be applied to the terminal or network device according to the embodiments of the present application, and the program enables the computer to execute the method executed by the terminal or network device in the embodiments of the present application.

The embodiment of the present application also provides a computer program. The computer program can be applied to the terminal or network device according to the embodiments of the present application, and the computer program enables the computer to execute the method executed by the terminal or network device in the embodiments of the present application.

It should be understood that the terms “system” and “network” in this application may be used interchangeably. In addition, the terms used in this application are merely to explain specific embodiments of this application, and are not intended to limit this application. The terms “first”, “second”, “third”, and “fourth” in the specification, claims, and accompanying drawings of this application are used to distinguish between different objects, and are not used to describe a specific sequence. In addition, the terms “include”, “have” and any variations thereof are intended to cover the inclusion of non-exclusive.

In the embodiments of this application, the mentioned “indication” may be a direct indication, an indirect indication, or an association relationship. For example, A indicates B, which may indicate that A directly indicates B, for example, B may be obtained based on A. Alternatively, it may indicate that A indirectly indicates B, for example, A indicates C, and B may be obtained based on C. It may further indicate that there is an association relationship between A and B.

In the embodiments of this application, “B corresponding to A” indicates that B is associated with A, and B may be determined according to A. However, it should be further understood that determining B according to A does not mean determining B according to A only, and may further determine B according to A and/or other information.

In the embodiments of this application, the term “correspondence” may indicate that there is a direct correspondence or an indirect correspondence between the two, or may indicate an association relationship between the two, or may indicate a relationship with indication, configuration, and configuration.

In the embodiments of this application, “predefined” or “pre-configured” may be implemented in a manner in which a corresponding code, table, or other related information may be pre-stored in a device (for example, a terminal device or a network device). A specific implementation manner of this application is not limited. For example, a predefined definition may refer to a definition in a protocol.

In the embodiments of this application, the “protocol” may refer to a standard protocol in the communications field, for example, may include an LTE protocol, an NR protocol, and a related protocol applied to a future communications system. This is not limited in this application.

In the embodiments of this application, the term “and/or” is merely an association relationship that describes an associated object, and indicates that three relationships may exist. For example, A and/or B may indicate that A exists separately, A and B exist simultaneously, and B exists separately. In addition, the character “/” in this specification generally indicates that the associated object is a “or” relationship.

In the embodiments of this application, the term “include” refers to direct inclusion as well as indirect inclusion. Optionally, the term “include” mentioned in the embodiments of this application can be replaced with “indicates” or “is used to determine”. For example, “A includes B” can be replaced with “A indicates B” or “A is used to determine B”.

In various embodiments of this application, a sequence number of the foregoing processes does not mean a sequence of execution. The execution sequence of the processes should be determined according to functions and internal logic of the processes, and should not constitute any limitation on an implementation process of the embodiments of this application.

In the embodiments provided in this application, it should be understood that the disclosed system, apparatus, and method may be implemented in another manner. For example, the described device embodiments are merely examples. For example, the unit division is merely logical function division. In actual implementation, there may be another division manner. For example, multiple units or components may be combined or integrated into another system, or some features may be ignored or not performed. On the other hand, the displayed or discussed mutual coupling or direct coupling or communication connection may be through some interfaces, indirect coupling or communication connection of the apparatus or unit, and may be in an electrical, mechanical, or other form.

The units described as separate parts may or may not be physically separate, and parts described as units may or may not be physical units, may be located in one place, or may be distributed on multiple network units. Some or all of the units may be selected according to an actual requirement to implement the objectives of the solutions in the embodiments.

In addition, functional units in the embodiments of this application may be integrated into one processing unit, or units may exist separately physically, or two or more units may be integrated into one unit.

In the above embodiments, all or part of them are implemented by software, hardware, firmware or any combination thereof. When software is used, the solution may be implemented in full or in part in the form of a computer program product. The computer program product includes one or more computer instructions. When the computer instructions are loaded and executed on the computer, a process or a function described in the embodiments of this application is completely or partially generated. The computer may be a general-purpose computer, a dedicated computer, a computer network, or another programmable apparatus. The computer instructions may be stored in a computer readable storage medium or transmitted from one computer readable storage medium to another computer readable storage medium. For example, the computer instructions may be transmitted from one website site, computer, server or data center to another website site, computer, server or data center in a wired (e.g., a coaxial cable, an optical fiber, a digital subscriber line (DSL)) or wireless (e.g., infrared, wireless, microwave) manner. The computer-readable storage medium is any available medium that can be read by a computer or a data storage device such as a server or a data center that includes one or more available media. The available medium is a magnetic medium (e.g., a floppy disk, a hard disk, a magnetic tape), an optical medium (e.g., a digital video disc (DVD)), or a semiconductor medium (e.g., a solid-state disk (SSD)).

The foregoing descriptions are merely specific implementations of this application, but are not intended to limit the protection scope of this application. Any change or replacement readily figured out by those skilled in the art within the technical scope disclosed in this application shall fall within the protection scope of this application. Therefore, the protection scope of this application shall be subject to the protection scope of the claims.

What is claimed is:

1. A wireless communications method, comprising:
transmitting, by a first terminal device, capability information; and
receiving, by the first terminal device, a first signal and a second signal that are sent by a first device, wherein the first signal and the second signal are used to determine first phase information that comprises a phase difference between the first signal and the second signal, a location at which the first device transmits the first signal is a first location, a location at which the first device transmits the second signal is a second location, and the first location is different from the second location, wherein the capability information indicates whether the first terminal device supports calculation of the phase difference between the first signal and the second signal.

2. The method according to claim 1, further comprising:
receiving, by the first terminal device, first information, wherein the first information comprises one or more of the following:
configuration information of the first signal and the second signal;
information indicating whether the first terminal device needs to calculate the phase difference between the first signal and the second signal;
information indicating whether signals sent by the first device support phase estimation for difference calculation; or
information indicating whether the first signal and the second signal support phase estimation for difference calculation.

3. The method according to claim 2, wherein the first information comprises information indicating one or more of the following:
a sending moment of the first signal;
a receiving moment of the first signal;
a sending moment of the second signal; or
a receiving moment of the second signal.

4. The method according to claim 3, wherein the sending moment or the receiving moment is represented by one or more of the following:
absolute time; or
a first time unit.

5. The method according to claim 4, wherein the first time unit comprises one or more of the following: a frame, a subframe, or an orthogonal frequency division multiplexing (OFDM) symbol.

6. The method according to claim 1, further comprising:
transmitting, by the first terminal device, the first phase information to a second device.

7. The method according to claim 6, wherein the second device comprises one or more of the following:
a positioning solving unit;
a positioning server;
a second terminal device serving as a central node; or
a first base station, wherein the first base station comprises at least one of a serving base station or a neighboring base station of the first terminal device.

8. The method according to claim 7, wherein in a case that the first terminal device moves out of a coverage area of the serving base station, the second device comprises the neighboring base station, and the first phase information is transmitted through an uplink grant allocated by the serving base station.

9. The method according to claim 8, wherein the uplink grant allocated by the serving base station is indicated by second information, and the second information is transmitted by the serving base station to the neighboring base station.

10. The method according to claim 7, wherein in a case that the first terminal device moves out of a coverage area of the serving base station, the second device comprises the neighboring base station, and the first phase information is transmitted through a first resource shared by the serving base station and the neighboring base station.

11. The method according to claim 10, wherein the first resource is obtained from a shared resource pool of the serving base station and the neighboring base station in a scheduling-free manner.

12. The method according to claim 1, wherein the first phase information is used to calculate a location of the first terminal device.

13. The method according to claim 1, wherein the first phase information is used to calculate the first location and the second location.

14. The method according to claim 13, wherein the first location and the second location are obtained by calculation based on information about the first device, wherein the information about the first device comprises one or more of the following:
a running track of the first device;
ephemeris information of the first device;
a moment at which the first device sends the first signal; or
a moment at which the first device sends the second signal.

15. The method according to claim 1, further comprising:
transmitting, by the first terminal device, third information to a second device, wherein the third information indicates one or more of the following: a relationship between the first phase information and the first signal; or a relationship between the first phase information and the second signal.

16. The method according to claim 1, wherein a transmission interval between the first signal and the second signal is greater than a threshold, and the threshold is related to one or more of the following:
a transmission delay between the first terminal device and the first device; or
a processing delay of the first terminal device.

17. The method according to claim 1, wherein the first signal comprises a first positioning reference signal (PRS), or the second signal comprises a second PRS.

18. The method according to claim 1, wherein a phase difference 40 between the first signal and the second signal meets:
$$Δ∅ = \frac{{f}_{2} {∅}_{1}}{{f}_{1}} - {∅}_{2} .$$
wherein f₁ represents a receiving frequency of the first signal, f₂ represents a receiving frequency of the second signal, Ø₁ represents a phase obtained by the first terminal device measuring the first signal, and Ø₂ represents a phase obtained by the first terminal device measuring the second signal.

19. A wireless communications method, comprising:
receiving, by a first device, capability information sent by a first terminal device; and
transmitting, by the first device, a first signal and a second signal to the first terminal device, wherein the first signal and the second signal are used to determine first phase information that comprises a phase difference between the first signal and the second signal, a location at which the first device transmits the first signal is a first location, a location at which the first device transmits the second signal is a second location, and the first location is different from the second location, wherein the capability information indicates whether the first terminal device supports calculation of the phase difference between the first signal and the second signal.

20. A first terminal device, comprises:
at least one processor; and
one or more non-transitory computer-readable storage media coupled to the at least one processor and storing programming instructions for execution by the at least one processor, wherein the programming instructions, when executed, cause the first terminal device to perform operations comprising:
transmitting capability information; and
receiving a first signal and a second signal that are sent by a first device, wherein the first signal and the second signal are used to determine first phase information that comprises a phase difference between the first signal and the second signal, a location at which the first device transmits the first signal is a first location, a location at which the first device transmits the second signal is a second location, and the first location is different from the second location, wherein the capability information indicates whether the first terminal device supports calculation of the phase difference between the first signal and the second signal.
